(19) United States
(12) Patent Application Publication
(10) Pub. No.: US 2016/0037780 A1
(43) Pub. Date: Feb. 11, 2016

(54) BORON CONTAINING COMPOUNDS AND USES THEREOF

(71) Applicant: EMPIRE TECHNOLOGY DEVELOPMENT LLC, Wilmington, DE (US)

(72) Inventors: William Brenden Carlson, Seattle, WA (US); Gregory David Phelan, Cortland, NY (US)

(21) Appl. No.: 14/777,238

(22) PCT Filed: Mar. 15, 2013
(86) PCT No.: PCT/US13/32476

§ 371 Date: Sep. 15, 2015

(51) Int. Cl. A01N 55/08; C07F 5/04; C07F 5/05; C07F 5/02

(52) U.S. Cl. CPC A01N 55/08; C07F 5/027; C07F 5/04; C07F 5/025; C07F 5/05

(57) ABSTRACT

Provided herein is a boron-containing compound, or salt thereof, as described herein and an excipient for the treatment of a cellulosic material. Also provided are compositions, polymers and articles including a cellulosic material and a boron-containing compound, and a process for preparing such an article. The boron-containing compound and compositions including the same can be used, for example, as a wood preservative or fire retardant.

### FIELD

The present technology relates to boron containing compounds for use as wood preservatives.

### BACKGROUND

The following description is provided to assist the understanding of the reader. None of the information provided or references cited is admitted to be prior art to the present technology.

Wood preservatives are used to deter or kill organisms that degrade wood (e.g., wood bearings, utility poles, railroad ties, landscape timbers, docking and marine structures). Many such conventional wood preservatives such as heavy metals or copper naphthenates are toxic to wood destroying organisms (e.g., bacteria, fungi, wood boring beetles, termites, marine organisms, and animals such as rodents), but have the disadvantage of also being generally toxic to the environment.

Further, to be most effective, wood preservatives must penetrate into the wood interior. To do so, many wood preservatives are formulated as liquids that are impregnated into wooden structures. The liquids typically remain fluid even after they are forced into the wood and are thus prone to leakage from the wood. Leakage of toxic wood preservatives impacts the environment and can raise maintenance costs due to the need for additional labor and materials for the upkeep necessary to reprotect wooden structures.

For example, when stored horizontally, wooden structures such as utility poles and railroad ties need to be turned periodically to prevent the fluid wood preservatives in the wood from being forced down and out of the utility poles by gravity. Further, fluid migration may leave installed wooden products unprotected, at the expense of the surrounding environment, as may be seen in telephone poles where the impregnated fluid has migrated downward and left the top dry and vulnerable. There is thus a need for an improved preservation technology based upon wood preservatives that are less susceptible to migration from the wood that is being preserved. There is a further need for an improved preservation technology based upon wood preservatives that include environmentally friendly materials.

### SUMMARY

The present technology provides for boron containing compounds that deter or kill organisms that degrade wood. The boron containing compounds include a polymerizable moiety that allows the compound to be polymerized in situ after being impregnated into wood products. As such, the compound is effectively fixed within treated wood to deter seepage from the wood and minimize environmental risks.

Processes for treating wood and wood products with the boron containing compounds are also provided. Wood is coated or impregnated under pressure with the boron containing compound, which compound is polymerized on the surface of the wood and/or within the interior of the wood. Whether the wood is surface treated or impregnated, the polymerized compound is effectively fixed. Optionally, pressure and vacuum may be applied in selected sequence to promote impregnation, and heat, blowing air, oxygen, ultraviolet light, and other agents may be employed to promote polymerization of the compound used to surface-treat or impregnate the wood. Additional additives may be used to prevent pest infestations and the growth of fungi, or to promote the migration of the boron containing compounds from the wood.

In one aspect, a compound of Formula I, or a salt thereof, is provided:

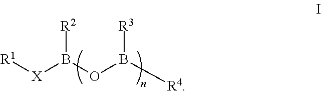

In Formula I, each R¹ is independently selected from a group consisting of a C₈-C₃₆ alkyl, C₈-C₃₆ alkenyl and combinations thereof, where the alkyl or alkenyl is optionally substituted with a C₃-C₇ cycloalkyl, C₃-C₇ cycloalkenyl or C₃-C₇ heterocycloalkyl; at least one R¹ is a C₈-C₃₆ polyunsaturated alkenyl optionally substituted with a C₃-C₇ cycloalkyl, C₃-C₇ cycloalkenyl or C₃-C₇ heterocycloalkyl; R², R³ and R⁴ are independently OH, F, C1, Br, I, O—C₁C₆alkyl, C₁-C₆ alkyl, OC(O)R¹, OCH₂R¹, or CH₂R¹; X is —C(O)O—, —CH₂O—, or —CH₂—; and n is 0, 1, 2, 3, 4 or 5.

In another aspect, a compound of Formula VI, or a salt thereof, is provided:

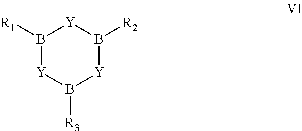

In Formula VI, each R¹ is independently selected from a group consisting of a C₈—C₃₆ alkyl, C₈-C₃₆ alkenyl and combinations thereof, where the alkyl or alkenyl is optionally substituted with a C₃-C₇ cycloalkyl, C₃-C₇ cycloalkenyl or C₃-C₇ heterocycloalkyl; at least one R¹ is a C₈-C₃₆ polyunsaturated alkenyl optionally substituted with a C₃-C₇ cycloalkyl, C₃-C₇ cycloalkenyl or C₃-C₇ heterocycloalkyl; R², R³ and R⁴ are independently OH, F, Cl, Br, I, O—C₁-C₆alkyl, C₁-C₆ alkyl, OC(O)R¹, OCH₂R¹, or CH₂R¹; and Y is O or F.

In another aspect, a composition is provided including any of the compounds of Formula I or VI, as described herein, and an excipient for the treatment of a cellulosic material.

In another aspect, a polymer is provided where the polymer is a reaction product of a compound of Formula I or VI, as described herein.

In another aspect, an article is provided where article includes a cellulosic material and a compound of Formula I or VI, or a polymerized reaction product of the compound of Formula I or VI, as described herein.

In another aspect, a process for preparing an article is provided, where the article includes a cellulosic material and a compound of Formula I or VI, or a polymerized reaction product of the compound of Formula I or VI, the process including: contacting a cellulosic material with a compound of Formula I or VI, and polymerizing the compound of Formula I or VI, as described herein.

The foregoing summary is illustrative only and is not intended to be in any way limiting. In addition to the illustrative aspects, embodiments and features described above, further aspects, embodiments and features will become apparent by reference to the following detailed description.

### DETAILED DESCRIPTION

The illustrative embodiments described in the detailed description and claims are not meant to be limiting. Other embodiments may be utilized, and other changes may be made, without departing from the spirit or scope of the subject matter presented here.

The present technology is described herein using several definitions, as set forth throughout the specification.

As used herein, unless otherwise stated, the singular forms “a,” “an,” and “the” include plural reference. Thus, for example, a reference to “a cell” includes a plurality of cells, and a reference to “a molecule” is a reference to one or more molecules.

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

As used herein, Cₘ-Cₙ, such as C₁-C₁₀, C₁-C₆, or C₁-C₄ when used before a group refers to that group containing m to n carbon atoms.

The term “alkyl” refers to monovalent saturated aliphatic hydrocarbyl groups having the specified number of carbon atoms. Where not specified, an alkyl includes from 1 to 24 carbon atoms (i.e., C₁-C₂₄). For example, alkyls may have 1, 2, 3, 4, 5, 6, 7, 8, 9, 10, 11, 12, 13, 14, 15, 16, 17, 18, 19, 20, 21, 22, 23, or 24 carbon atoms or ranges between and including any two of the foregoing values (e.g., C₁-C₁₀ alkyl, C₁-C₆ alkyl, C₁-C₄ alkyl, and the like). This term includes, by way of example, linear and branched hydrocarbyl groups such as methyl (CH₃—), ethyl (CH₃CH₂—), n-propyl (CH₃CH₂CH₂—), isopropyl ((CH₃)₂CH—), n-butyl (CH₃CH₂CH₂CH₂—), isobutyl ((CH₃)₂CHCH₂—), sec-butyl ((CH₃)(CH₃CH₂)CH—), t-butyl ((CH₃)₃C—), n-pentyl (CH₃CH₂CH₂CH₂CH₂—), and neopentyl ((CH₃)₃CCH₂—). Alkyl groups may optionally be substituted. Representative substituted alkyl groups may be mono-substituted or substituted more than once, such as, but not limited to, mono-, di- or tri-substituted with substituents such as those listed herein.

Alkenyl groups include straight and branched chain alkyl groups as defined above, except that at least one double bond exists between two carbon atoms. Thus, alkenyl groups have from 2 to 24 carbon atoms. For example, alkenyls may have 2, 3, 4, 5, 6, 7, 8, 9, 10, 11, 12, 13, 14, 15, 16, 17, 18, 19, 20, 21, 22, 23, or 24 carbon atoms or ranges between and including any two of the foregoing values (e.g., C₂-C₁₀ alkenyl, C₂-C₆ alkenyl, C₂-C₄ alkenyl, and the like). Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, among others. Alkenyl groups may optionally be substituted. Representative substituted alkenyl groups may be mono-substituted or substituted more than once, such as, but not limited to, mono-, di- or tri-substituted with substituents such as those listed herein.

The terms “alkylene,” “cycloalkylene,” and “alkenylene,” alone or as part of another substituent means a divalent radical derived from an alkyl, cycloalkyl, or alkenyl group, respectively, as exemplified by —CH₂CH₂CH₂CH₂—. For alkylene, cycloalkylene, and alkenylene linking groups, no orientation of the linking group is implied.

The term “aryl” refers to a monovalent, aromatic mono- or bicyclic ring having 6-10 ring carbon atoms. Examples of aryl include phenyl and naphthyl. Aryl groups may be substituted. Representative substituted aryl groups include mono-, di-, tri-, tetra- and penta-substituted aryls with substituents such as those listed herein.

The term “cycloalkyl” refers to a monovalent, preferably saturated, hydrocarbyl mono-, bi-, or tricyclic ring having 3-12 ring carbon atoms. While cycloalkyl refers preferably to saturated hydrocarbyl rings, as used herein, it also includes rings containing 1-2 carbon-carbon double bonds. Nonlimiting examples of cycloalkyl include cyclopropyl, cyclobutyl, cyclopentyl, cyclohexyl, cycloheptyl, adamentyl, and the like. Cycloalkyl groups may be substituted in the same way that alkyl groups may be substituted.

The term “heteroaryl” refers to a monovalent, aromatic mono-, bi-, or tricyclic ring having 2-14 ring carbon atoms and 1-6 ring heteroatoms selected preferably from N, O, S, and P and oxidized forms of N, S, and P, provided that the ring contains at least 5 ring atoms. Nonlimiting examples of heteroaryl include furan, imidazole, oxadiazole, oxazole, pyridine, quinoline, and the like. Heteroaryl groups may be substituted in the same way that aryl groups may be substituted.

The term “heterocyclyl” or heterocycle refers to a non-aromatic, mono-, bi-, or tricyclic ring containing 2-10 ring carbon atoms and 1-6 ring heteroatoms selected preferably from B, N, O, S, and P and oxidized forms of B, N, S, and P, provided that the ring contains at least 3 ring atoms. While heterocyclyl preferably refers to saturated ring systems, it also includes ring systems containing 1-3 double bonds, provided that they ring is non-aromatic. Nonlimiting examples of heterocyclyl include, azalactones, oxazoline, piperidinyl, piperazinyl, pyrrolidinyl, tetrahydrofuranyl, and tetrahydropyranyl. Further examples include heterocycle rings having B—C bonds, B—O—C bonds and/or B—O—C(═O)—C bond systems. Heterocyclyl groups may be substituted in the same way that aryl groups may be substituted.

The term “salt” refers to an ionic compound formed between an acid and a base. When the compound provided herein contains an acidic functionality, such salts include, without limitation, alkali metal, alkaline earth metal, and ammonium salts. As used herein, ammonium salts include, salts containing protonated nitrogen bases and alkylated nitrogen bases. Exemplary and non-limiting cations useful in pharmaceutically acceptable salts include Na, K, Rb, Cs, NH₄, Ca, Ba, imidazolium, and ammonium cations based on naturally occurring amino acids. When the compounds utilized herein contain basic functionally, such salts include, without limitation, salts of organic acids, such as carboxylic acids and sulfonic acids, and mineral acids, such as hydrogen halides, sulfuric acid, phosphoric acid, and the likes. Exemplary and non-limiting anions useful in pharmaceutically acceptable salts include oxalate, maleate, acetate, propionate, succinate, tartrate, chloride, sulfate, bisulfate, mono-, di-, and tribasic phosphate, mesylate, tosylate, and the likes.

The term “amine” (or “amino”) as used herein refers to —NHR and —NRR′ groups, where R, and R′ are independently hydrogen, or a substituted or unsubstituted alkyl, alkenyl, alkynyl, cycloalkyl, aryl or aralkyl group as defined herein. Examples of amino groups include
—NH₂, methylamino, dimethylamino, ethylamino, diethylamino, propylamino, isopropylamino, phenylamino, benzylamino, and the like.

The term “alkoxy” refers to —O-alkyl.

The term “halo” refers to F, Cl, Br, and/or I.

The term “oxo” refers to a C═O group, and to a substitution of two geminal hydrogen atoms with a CO═O group.

“Substituted” refers to a chemical group as described herein that further includes one or more substituents, such as lower alkyl (including substituted lower alkyl such as haloalkyl, hydroxyalkyl, aminoalkyl), aryl (including substituted aryl), acyl, halogen, hydroxy, amino, alkoxy, alkylamino, acylamino, thioamido, acyloxy, aryloxy, aryloxyalkyl, carboxy, thiol, sulfide, sulfonyl, oxo, both saturated and unsaturated cyclic hydrocarbons (e.g., cycloalkyl, cycloalkenyl), cycloheteroalkyls and the like. These groups may be attached to any carbon or substituent of the alkyl, alkenyl, alkynyl, aryl, cycloheteroalkyl, alkylene, alkenylene, alkynylene, arylene, hetero moieties. Additionally, the substituents may be pendent from, or integral to, the carbon chain itself.

The term “borane” refers to a boron containing compound having three optionally substituted alkyl, alkenyl, alkynyl, cycloalkyl, cycloalkenyl, heterocyclyl, aryl, or heteroaryl in which a carbon atom of each group is covalently bound to boron. The term “borate” refers to a boron containing compound having at least one optionally substituted oxygen atom covalently bound to boron. As used herein, borates may also have, in addition to at least one optionally substituted oxygen atom covalently bound to boron, one or two optionally substituted alkyl, alkenyl, alkynyl, cycloalkyl, cycloalkenyl, heterocyclyl, aryl, or heteroaryl groups in which a carbon atom of each group is covalently bound to boron.

The term “cellulosic material” refers to any cellulose-based material or article. The term “cellulosic material” further includes “wood” or “wood product” or cellulosic composite materials that include wood or wood products as these terms are defined herein.

The terms “wood” or “wood product” include any wood and wood-based materials, including but not limited to wood bearings, utility poles, railroad ties, landscape timbers, docking and marine structures, logs, dried lumber, green lumber, fiberboards, strand board, laminated veneer lumber, wood composites, plastic wood composites, and engineered wood formed from wood chips. The wood may be softwood or hardwood. The softwood may include pine species and spruce species, for example, heartwood or sapwood.

The present technology provides for boron containing compounds that deter or kill organisms that degrade wood, and a polymerizable moiety (e.g., a mono- or poly-olefin moiety) that allows the compound to be polymerized in situ after being impregnated into a cellulosic material such as wood or wood products. As such, the compound is effectively fixed within treated wood to deter seepage from the wood and minimize environmental risks.

In one aspect, a compound of Formula I, or a salt thereof, is provided:

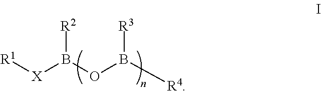

In Formula I, each R¹ is independently selected from a group consisting of a C₈-C₃₆ alkyl, C₈-C₃₆ alkenyl and combinations thereof, where the alkyl or alkenyl is optionally substituted with a C₃-C₇ cycloalkyl, C₃-C₇ cycloalkenyl or C₃-C₇ heterocycloalkyl; at least one R¹ is a C₈-C₃₆ polyunsaturated alkenyl optionally substituted with a C₃-C₇ cycloalkyl, C₃-C₇ cycloalkenyl or C₃-C₇ heterocycloalkyl; R², R³ and R⁴ are independently OH, F, Cl, Br, I, O—C₁-C₆-alkyl, C₁-C₆ alkyl, OC(O)R¹, OCH₂R¹, or CH₂R¹; X is —C(O)O—, —CH₂O—, or —CH₂—; and n is 0, 1, 2, 3, 4 or 5.

In some embodiments, a composition is provided including any of the compounds described herein and an excipient for the treatment of a cellulosic material.

In some embodiments, X is —C(O)O—. In some embodiments, X is —CH₂O—. In some embodiments, X is or —CH₂—.

In some embodiments, the compound of Formula I is of Formula II:

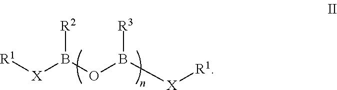

In Formula II, each X is —C(O)O— or —CH₂O—.

In some embodiments, n is 0. In some embodiments, n is 1.

In some embodiments, R² is OH. In some embodiments, R² is C₁-C₆ alkyl. In some embodiments, R² is butyl. In some embodiments, R² is —OC(O)R¹, —OCH₂R¹, or CH₂R¹. In some embodiments, R² and R³ are the same. In some embodiments, R² and R⁴ are the same.

In some embodiments, the compound of Formula I is of Formula III:

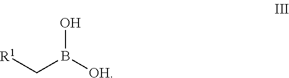

In some embodiments, the compound of Formula I is of Formula IV:

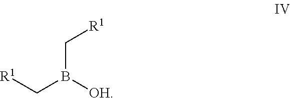

In some embodiments, the compound of Formula I is of Formula V:

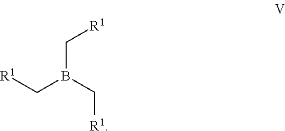

In some embodiments, each R¹ is a C₈-C₃₆ alkyl or C₈-C₃₆ alkenyl independently selected from the hydrocarbon chain of lauric acid, myristic acid, myristoleic acid, palmitic acid, stearic acid, oleic acid, palmitoleic acid, or vaccenic acid, hexadecatrienoic acid, linoleic acid, a-linolenic acid, -linolenic acid, stearidonic acid, eicosatrienoic acid, eicosatetraenoic acid, eicosapentenoic acid, heneicosapentenoic acid, docosapentenoic acid, docosahexaenoic acid, tetracosapentenoic acid, tetracosahexaenoic acid, sapienic acid, elaidic acid, linoelaidic acid, α-eleostearic acid, -eleostearic acid, arachidonic acid, erucic acid, caprylic acid, capric acid, arachidic acid, behenic acid, lignoceric acid, cerotic acid and combinations thereof.

In some embodiments, each R¹ is a combination of C₈-C₃₆ alkyl and/or C₈-C₃₆ alkenyl groups from hydrocarbon chains of an oil selected from the group consisting of linseed, safflower, soybean, sunflower, tung, tall, castor, coconut, flaxseed, Omega-3, cotton, palm, canola, corn, oatmeal, almond peanut, grape, olive, fish and combinations thereof.

In another aspect, a compound of Formula VI, or a salt thereof, is provided:

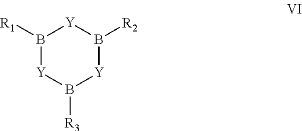

In Formula VI, each R¹ is independently selected from a group consisting of a C₈-C₃₆ alkyl, C₈-C₃₆ alkenyl and combinations thereof, where the alkyl or alkenyl is optionally substituted with a C₃-C₇ cycloalkyl, C₃-C₇ cycloalkenyl or C₃-C₇ heterocycloalkyl; at least one R¹ is a C₈-C₃₆ polyunsaturated alkenyl optionally substituted with a C₃-C₇ cycloalkyl, C₃-C₇ cycloalkenyl or C₃-C₇ heterocycloalkyl; R², R³ and R⁴ are independently OH, F, Cl, Br, I, O—C₁-C₆-alkyl, C₁-C₆ alkyl, OC(O)R¹, OCH₂R¹, or CH₂R¹; and Y is O or F.

In some embodiments, a composition is provided including any of the compounds described herein and an excipient for the treatment of a cellulosic material.

In Formula VI, each X is —C(O)O— or —CH₂O—.

In some embodiments of the compound of Formula VI, R², R³ and R⁴ are OH. In some embodiments, R², R³ and R⁴ are F, Cl, Br or I. In some embodiments, R², R³ and R⁴ are O—C₁-C₆-alkyl. In some embodiments, R², R³ and R⁴ are C₁-C₆ alkyl. In some embodiments, R², R³ and R⁴ are OC(O)R¹. In some embodiments, R², R³ and R⁴ are OCH₂R¹. In some embodiments, R², R³ and R⁴ are or CH₂R¹.

In some embodiments, Y is O. In some embodiments, Y is F.

In another aspect, a composition is provided including any of the compounds of Formula I or VI, as described herein, and an excipient for the treatment of a cellulosic material.

In some embodiments, the composition is a fire retardant. A fire retardant reduces flammability of fuels or delays their combustion. In some embodiments, the composition further comprises a fire retardant fire retardant additives include mixtures of huntite and hydromagnesite, aluminium hydroxide, magnesium hydroxide and combinations thereof.

The compositions may include, but are not limited to, paints, sealant, coatings, polymers, and the like. Such compositions include a polypeptide and at least one excipient, i.e., additive for the treatment of a cellulosic material that is known in the art.

Examples of a suitable excipient for the treatment of a cellulosic material include, but are not limited to, an oil, drier, pigment, leveling agent, flatting agent, dispersing agent, flow control agent, ultraviolet (UV) absorber, plasticizer, solvent, stabilizer, antioxidant and a combination thereof. Specific examples of such excipients can be found in Raw Materials Index, published by the National Paint & Coatings Association, 1500 R.I. Avenue, N.W., Washington, D.C. 20005.

Illustrative driers include, but are not limited to, various salts of cobalt, iron, manganese, cobalt, lead, manganese, calcium, zinc, zirconium, bismuth, lithium, aluminum, barium, cerium, vanadium, lanthanum, neodymium, iron, sodium, or potassium, or combinations thereof. The driers may include as the salt octoates or naphthenates, in an amount of about 0.005 wt. % to about 0.5 wt. % metal, based on the polypeptide. A description of metal driers, their functions, and methods for using them may be found in Handbook of Coatings Additives, p. 496-506, ed. by L. J. Calbo, Marcel Dekker, New York, N.Y., 1987.

Where the composition includes a pigment, the pigments may be organic or inorganic, including those set forth by the Colour Index, 3d Ed., 2d Rev., 1982, published by the Society of Dyers and Colourists in association with the American Association of Textile Chemists and Colorists. Other examples of suitable pigments include, but are not limited to, titanium dioxide, barytes, clay, calcium carbonate, CI Pigment White 6 (titanium dioxide), CI Pigment Red 101 (red iron oxide), CI Pigment Yellow 42, CI Pigment Blue (copper phthalocyanines); CI Pigment Red 49:1 and CI Pigment Red 57:1. Colorants such as, for example, phthalocyanine blue, molybdate orange, or carbon black, may be added to the a formulation.

Where the composition includes a leveling agent, illustrative agents include, but are not limited to, silicones, fluorocarbons, cellulosics, extenders, plasticizers, and combinations thereof. Where the composition includes a flatteing agent, illustrative agents include, but are not limited to, synthetic silica, and synthetic silicate.

Where the composition includes a dispersing agent, illustrative agents include, but are not limited to, sodium bis(tridecyl)sulfosuccinate, di(2-ethyl hexyl)sodium sulfosuccinate, sodium dihexylsulfosuccinate, sodium dicyclohexyl sulfosuccinate, diamyl sodium sulfosuccinate, sodium diisobutyl sulfosuccinate, disodium iso-decyl sulfosuccinate, disodium ethoxylated alcohol half ester of sulfosuccinic acid, disodium alkyl amido polyethoxy sulfosuccinate, tetra-sodium N-(1,2-dicarboxyethyl)-N-octadecyl sulfosuccinamate, disodium N-octasulfosuccinamate, and sulfated ethoxylated nonylphenol, 2-amino-2-methyl-1-propanol.

Where the composition includes a flow control agent, illustrative agents include, but are not limited to, polyaminoamide phosphate, high molecular weight carboxylic acid salts of polyamine amides, and alkylene amine salts of an unsaturated fatty acid. Further examples include, but are not limited to, polysiloxane copolymers, polyacrylate solution, cellulose esters, hydroxyethyl cellulose, hydroxypropyl cellulose, polyamide wax, polyolefin wax, hydroxypropyl methyl cellulose, and polyethylene oxide.

Where the composition includes an ultraviolet (UV) absorber, illustrative absorbers include, but are not limited to, substituted benzophenone, substituted benzotriazoles, hindered amines, and hindered benzoates, diethyl-3-acetyl4-hydroxy-benzyl-phosphonate, 4-dodecyloxy-2-hydroxy benzophenone, and resorcinol monobenzoate.

Where the composition includes a plasticizer, illustrative plasticizers include, but are not limited to mono C₈-C₂₄ fatty acids, C₈-C₂₄ saturated fatty acids, and phthalate esters such as di-2-ethyl hexyl phthalate (DEHP), diisodecyl phthalate (DIDP), diisononyl phthalate (DINP), and benzylbutylphthalate (BBP).

Illustrative solvents for use in the compositions include both aqueous and non-aqueous solvent. For example, water and organic solvents may be used. Illustrative organic solvents include, but are not limited to, ethanol, n-propanol, isopropanol, n-butanol, sec-butanol, isobutanol, ethylene glycol, monobutyl ether, propylene glycol n-butyl ether, propylene glycol methyl ether, propylene glycol monopropyl ether, dipropylene glycol methyl ether, diethylene glycol monobutyl ether, methylene chloride (dichloromethane), 1,1,1-trichloroethane(methyl chloroform), 1,1,2-trichloro-1,2,2-trifluoroethane (CFC-113), trichlorofluoromethane (CFC-11), dichlorodifluoromethane (CFC-12), chlorodifluoromethane (HCFC-22), trifluoromethane (HFC-23), 1,2-dichloro-1,1,2,2-tetrafluoroethane (CFC-114), chloropentafluoroethane (CFC-115), 1,1,1-trifluoro 2,2-dichloroethane (HCFC-123), 1,1,1,2-tetrafluoroethane (HCFC-134a), 1,1-dichloro-1-fluoroethane (HCFC-141b), 1-chloro-1,1-difluoroethane (HCFC-142b), 2-chloro-1,1,1,2-tetrafluorothane (HCFC-124), pentafluoroethane (HFC-125), 1,1,2,2-tetrafluoroethane (HFC-134), 1,1,1-trifluuoroethane (HFC-143a), 1,1-difluoroethane (HFC-152a), parachlorobenzotrifluoride (PCBTF), cyclic, branched, or linear completely methylated siloxanes, acetone, perchloroethylene (tetrachloroethylene), 3,3-dichloro-1,1,1,2,2-pentafluoropropane (HCFC-225ca), 1,3-dichloro-1,1,2,2,3-pentafluoropropane (HCFC-225cb), 1,1,1,2,3,4,4,5,5,5-decafluoropentane (HFC-43-10mee), difluoromethane (HFC-32), ethylfluoride (HFC-161), 1,1,1,3,3,3-hexafluoropropane (HFC-236fa), 1,1,2,2,3-pentafluoropropane (HFC-245ca), 1,1,2,3,3-pentafluoropropane (HFC-245ea), 1,1,1,2,3-pentafluoropropane (HFC-245eb), 1,1,1,3,3-pentafluoropropane (HFC-245fa), 1,1,1,2,3,3-hexafluoropropane (HFC-236ea), 1,1,1,3,3-pentafluorobutane (HFC-365-mfc), chlorofluoromethane (HCFC-31), 1-chloro-1-fluoroethane (HCFC-151a), 1,2-dichloro-1,1,2-trifluoroethane (HCFC-123a), 1,1,1,2,2,3,3,4,4-nonafluoro-4-methoxy-butane (C₄F₉OCH₃), 2-(difluoromethoxymethyl)-1,1,1,2,3,3,3-heptafluoropropane ((CF₃)₂CFCF₂OCH₃), and 1-ethoxy-1,1,2,2,3,3,4,4,4-nonafluorobutane.

The composition may include one or more stabilizers. In some embodiments, the one or more stabilizers include an antioxidant, a UV absorber, a heat stabilizer, a light stabilizer, or a combination of any two or more thereof. On a weight to weight percent basis, the composition may include one or more stabilizers in an amount of about 0.1 wt % to 99.0 wt %. This may include from about 1.0 wt % to about 10.0 wt %, or from about 10.0 wt % to about 20.0 wt %, or from about 20.0 wt % to about 40.0 wt %, or from about 40.0 wt % to about 60.0 wt %, or from about 60.0 wt % to about 80.0 wt %, or from about 80.0 wt % to about 99.0 wt %, and ranges between any two of these values.

Illustrative antioxidants include 2,6-di-tert-butyl-4-(4,6-bis(octylthio)-1,3,5-triazin-2-ylamino)phenol, N,N′-di-2-butyl-1,4-phenylene-diamine, stearyl-3-(3′,5′-di-tert-butyl-4 hydroxphenyl)propionate, dioctadecyl 3,3′-thiodipropionate, and combinations of any two or more such antioxidants. Illustrative UV absorbers include 2-benzotriazol-2-yl-4,6-bis-(1,1-dimethyl-propyl)-phenol, 2-(4,6-diphenyl-[1,3,5]triazin-2-yl)-phenol, (2-hydroxy-4-octyloxy-phenyl)-phenyl-methanone, and combinations of any two or more such UV absorbers. Illustrative light stabilizers include hindered amines such as 2,2,6,6-tetramethyl piperidine, bis(1,2,2,6,6-pentamethyl-4-piperidinyl)sebacate, poly[[6-[(1,1,3,3,-tetramethylbutyl)amino]-s-triazine-2,4-diyl][2,2,6,6-tetramethyl-4-piperidyl)imino]]hexamethylylene[(2,2,6,6-tetramethyl-4-piperidyl)imino]], and combinations of any two or more such light stabilizers. Illustrative heat stabilizers include butyl tin carboxylate, barium zinc, tris(2,4-ditert-butylphenyl)phosphate, and combinations of any two or more such heat stabilizers.

In another aspect, a polymer is provided where the polymer is a reaction product of a compound of Formula I or VI. The groups in Formula I or VI are as described above.

In some embodiments of the polymer, the first and second R¹ groups are joined by a bond, O, O—O, or a combination thereof. In certain embodiments, the polymer has a weight average molecular weight of about 5,000 to about 2,000,000 g/mol. For example, the polymer may have a weight average molecular weight of about 100,000 to about 1,000,000 g/mol.

In another aspect, an article is provided where article includes a cellulosic material and a compound of Formula I or VI or a polymerized reaction product of the compound of Formula I or VI. The groups in Formula I or VI are as described above. In certain embodiments, the composition includes cellulosic material that is wood, and the composition is a wood-polymer composite material that includes a boron containing compound.

In some embodiments, the cellulosic material is wood. For example, the wood may be a wood bearing, utility pole, railroad tie, landscape timber, docking and marine structure, log, dried lumber, green lumber, fiberboard, strand board, laminated veneer lumber, wood composite, plastic wood composite, and engineered wood formed from wood chips. The wood may be softwood or hardwood. The softwood may include pine species and spruce species, for example, heartwood or sapwood.

For example, in some embodiments the article is selected from the group consisting of a railroad tie, utility pole, building member, wood crafted item, toy, art work, picture frame, fencing, lumber, rib, frame, strut, support member, paper product, cardboard, packaging, storage item, construction item, decking, shelving, shingle, siding, cutting board, clothing and furniture. In some embodiments, the article is flame resistant.

In another aspect, a process for preparing an article is provided, where the article includes a cellulosic material and a compound of Formula I or VI or a polymerized reaction product of the compound of Formula I or VI, the process including: contacting a cellulosic material with a compound of Formula I or VI; and polymerizing the compound of Formula I or VI. The groups in Formula I or VI are as described above.

The contacting step may include employing a pressure process, a full cell process, or a fluctuation pressure process to impregnate the compound into the cellulosic material. For example, cellulosic materials such as woods typically are porous and the compounds may be forced into the porous structure by pressuring the system. Alternatively, a vacuum/pressurization process may be used, where a vacuum is drawn on the cellulosic material to withdraw some gases or low boiling point compounds from the cellulosic material and a subsequent pressurization forces the compound of Formula I or VI into the cellulosic material.

The polymerizing step may also include activating the compound of Formula I or VI. For example, the activating of the compound of Formula I or VI may include heating the compound of Formula I or VI, applying ultraviolet irradiation to the compound of Formula I or VI, adding a thermal initiator to the compound of Formula I or VI, or adding a photochemical initiator to the compound of Formula I or VI.

Where the activating the compound of Formula I or VI includes adding a thermal initiator to the compound of Formula I or VI, the thermal initiator may include, but is not limited to, 4,4-azobis(4-cyanovaleric acid), 1,1′-azobis(cyclohexanecarbonitrile), 2,2′-azobisisobutyronitrile, benzoyl peroxide, tert-butyl peracetate, lauroyl peroxide, or dicumyl peroxide. Where the activating the compound of Formula I or VI includes adding a photochemical initiator to the compound of Formula I or VI, the initiator may include, but is not limited to, 3-butyl-2-[5-(1-butyl-3,3-dimethyl-1,3-dihydro-indol-2-ylidene)-penta-1,3-dienyl]-1,1-dimethyl-1H-benzo[e]indolium triphenylbutylborate, 3-butyl-2-[5-(3-butyl-1,1-dimethyl-1,3-dihydro-benzo[e]indol-2-ylidene)-penta-1,3-dienyl]-1,1-dimethyl-1H-benzo[e]indolium triphenylbutylborate, or 6-hydroxy-2,4,5,7-tetraiodo-3-oxo-9,9a-dihydro-3H-xanthene-9-carbonitrile. In some embodiments, the step of activating the compound of Formula I or VI includes heating the compound of Formula I or VI to a temperature of about 40° C. to about 120° C.

In some embodiments, the process further includes contacting the compound of Formula I or VI with a metal catalyst drier.

In some embodiments of the process, the metal is cobalt, iron, manganese, cobalt, lead, manganese, calcium, zinc, zirconium, bismuth, lithium, aluminum, barium, cerium, vanadium, lanthanum, neodymium, iron, sodium, potassium or combinations thereof.

The process for treating cellulosic materials such as wood and wood products with a boron containing compound, or composition including the same, may include applying a compound of Formula I or VI, or a composition or solution thereof, into wood under a pressure regime to infuse the compound into the wood. Such methods of infusion may optionally further include the selective application of increased pressure or vacuum. In further embodiments, methods are provided that involve an additional step of polymerizing, in-situ, the compound of Formula I or VI within the wood. Both steps, which are described more thoroughly below, can be conducted separately or simultaneously.

Before applying the composition or solution of a compound of Formula I or VI, the wood may optionally be seasoned until a substantial fraction of free water has been removed from the cell spaces, with the resulting seasoned wood having its moisture content reduced by at least 25%, or at least 50%, or at least 75%, varying slightly with different species of wood. In certain embodiments, decreasing the moisture content of the wood creates more space to apply the preservative solution of a compound of Formula I or VI into the wood, and decreases the likelihood that splits will develop in the applied wood. In certain embodiments, cutting, machining, and/or boring of the wood is conducted before applying the composition or solution of a compound of Formula I or VI.

The composition or solution of a compound of Formula I or VI may be applied to wood by dipping, soaking, spraying, brushing, injecting, or any other well-known technique. The composition or solution of a compound of Formula I or VI may be applied at ambient temperature, but advantageously, can also be heated to assist penetration of the compound into the wood. In certain embodiments, methods are provided in which the composition or solution of a compound of Formula I or VI is applied to the wood by impregnating it into the wood. In still other embodiments, the composition or solution of a compound of Formula I or VI is applied as a surface coat which is polymerized to encapsulate the wood.

On a weight to weight percent basis, the compound of Formula I or VI can be present in the composition or solution in an amount of about 0.01 wt. % to about 99.0 wt. %. This may include from about 0.10 wt. % to about 3.0 wt. %, or from about 0.10 wt. % to about 2.0 wt. %, or from about 0.10 wt. % to about 1.0 wt. %, or from about 0.10 wt. % to about 0.50 wt. %, or from about 0.10 wt. % to about 0.30 wt. %. Specific examples of weight percent include about 0.01 wt. %, about 0.10 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 20 wt. %, about 30 wt. %, about 40 wt. %, about 50 wt. % about 99 wt. % and ranges between any two of these values.

On a weight to weight percent basis, the composition or solution of a compound of Formula I or VI will be present in the final wood product in an amount of about 0.01 wt. % to about 90.0 wt. %. This may include from about 0.10 wt. % to about 3.0 wt. %, or from about 0.10 wt. % to about 2.0 wt. %, or from about 0.10 wt. % to about 1.0 wt. %, or from about 0.10 wt. % to about 0.50 wt. %, or from about 0.10 wt. % to about 0.30 wt. %. Specific examples of weight percent include about 0.01 wt. %, about 0.10 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 20 wt. %, about 30 wt. %, about 40 wt. %, about 50 wt. %, about 90 wt. % and ranges between any two of these values.

The wood may also be treated with one or more additives either before, after, or simultaneously upon treatment with the preservative solution of a compound of Formula I or VI. These other additives may include solvents such as glycol-based solvents, water repellents, such as waxes, resins, or polymers, fire retardants, such as phosphates, mildewicides, insecticides, mouldicides, or pigments. One or more of these additives may be applied before the preservative solution of a compound of Formula I or VI. One or more of these additives may be applied after the preservative solution of a compound of Formula I or VI. In certain embodiments, one or more of these additives may be applied simultaneously with the preservative solution of a compound of Formula I or VI.

A vacuum or decreased pressure can be applied to degas the wood sample and to maximize pore sizes within the wood prior to the application of the preservative solution of a compound of Formula I or VI. Vacuum and/or pressure techniques may also be used to impregnate the wood, including both the “Empty Cell” process and the “Full Cell” process, both of which are well known to those skilled in the art. In certain embodiments, existing processes are used to impregnate the wood with the preservative solution of a compound of Formula I or VI, including the Bethell, Lowry, Reuping, and MSU processes.

The Bethell process involves using an initial vacuum to remove air from the wood cells and then flooding a cylinder loaded with the wood under vacuum with a preservative solution of a compound of Formula I or VI. Positive pressure of, for example, about 1400 kPa is then applied for a predetermined time, the preservative solution of the compound of Formula I or VI is drained and a final vacuum is drawn.

In the Lowry process, no initial vacuum is applied and the cylinder is flooded under atmospheric pressure with a preservative solution of a compound of Formula I or VI. Positive pressure of, for example, about 1400 kPa is then applied for a predetermined period, the cylinder is then drained and a final vacuum drawn. The net uptake of the preservative solution of a compound of Formula I or VI is lower because the air is not removed from the wood cells but is compressed during treatment, thus resulting in kickback of the preservative solution of a compound of Formula I or VI when pressure is released and the timber evacuated.

The Reuping process involves applying an initial air pressure of, for example, about 350 kPa to the wood in the cylinder and then flooding the cylinder with a solution of the preservative solution of a compound of Formula I or VI while holding this initial air pressure. Increased pressure of, for example, about 1000 kPa is then applied and, after a predetermined time, the pressure is released and the cylinder drained. A final vacuum is then drawn. This process has a lower net uptake of the preservative solution of a compound of Formula I or VI than both the Bethell and Lowry processes.

The MSU process is a modification of the Reuping process. The Reuping process is carried out but the cylinder is drained while maintaining a pressure of, for example, about 300 kPa. Heat is then applied by steaming the wood. After the steaming period, kickback is allowed to occur by reducing the pressure and a final vacuum is drawn.

Depending on the degree of saturation that is desired, pre- and post-impregnation vacuum application may be employed or eliminated. In certain embodiments, the preservative solution of a compound of Formula I or VI may be preheated to accelerate impregnation and to increase the level of penetration into the wood as well as to promote polymerization of the compound of Formula I or VI during the impregnation process.

The polymerization prevents, or at least minimizes, later leaching of the compound of Formula I or VI, and the preservative solution thereof, from the wood. Depending on the application and the potential detrimental effects of selected additives, it may be desirable to promote a greater degree of polymerization throughout the wood to fully solidify the compound of Formula I or VI or it may be desired to allow the preservative solution of the compound of Formula I or VI within the wood to remain slightly fluid. In certain embodiments, the method provides a polymerized solid surface coat of the preservative solution of the compound of Formula I or VI.

In-situ polymerization of the compound of Formula I or VI during and after impregnation of the wood can be promoted by conventional means. In certain embodiments, the in-situ polymerization includes activating the compound of Formula I or VI. In other embodiments, activating the compound of Formula I or VI includes heating, activating the compound of Formula I or VI with electromagnetic radiation, adding a thermal initiator, or adding a photochemical initiator. Electromagnetic radiation includes radiation from the electromagnetic spectrum having a wavelength from 0.1 angstrom (Å) to 1,000 meters (m). In certain embodiments, activating the compound of Formula I or VI includes activating the compound with ultraviolet (UV), visible, or near-infrared (IR) radiation. UV radiation has a wavelength from about 10 nm to about 390 nm. Visible radiation has a wavelength from about 390 nm to about 750 nm. Near-IR radiation has a wavelength from about 750 nm to about 3 μm. In certain embodiments, the in-situ polymerization is promoted through the application of heat. In certain embodiments, the in-situ polymerization is promoted by adding a thermal initiator.

The amount and duration of heat to be applied varies depending, for example, upon the size of the wood under treatment or the nature of the wood. As stated, in-situ polymerization of the compound of Formula I or VI serves to fix the compound of Formula I or VI within the wood, or at least increase the compound's viscosity within the wood, together with any additives from the preservative solution.

In certain embodiments, in-situ polymerization of the compound of Formula I or VI is promoted through the application of UV radiation. In certain embodiments, in-situ polymerization is promoted by adding a photochemical initiator. In certain embodiments, the polymerization is promoted through the application of heat.

In certain embodiments, methods are provided to surface treat the wood with a layer of the preservative solution of a compound of Formula I or VI and polymerize the surface layer to encapsulate the wood. In other embodiments, the surface layer of the compound of Formula I or VI is polymerized with the application of heat or ultraviolet radiation.

The present technology, thus generally described, will be understood more readily by reference to the following Examples, which are provided by way of illustration and are not intended to be limiting of the present technology.

### EXAMPLES

### Example 1

Synthesis of mono, bis, and tris linoleic borane wood preservatives See Scheme 1 below. Linoleic bromide has been reported. See e.g., Baker, J. A.; and McCrea, P. A. (1961) Journal of the Chemical Society 3854-3858. The synthesis of Grignard reagents of linoleic structure has also been reported. See e.g., M. Manoharam et al., WO 2010054406. Linoleic bromide 1 is dissolved into anhydrous diethyl ether containing a slight excess of clean magnesium turnings. The solution turns from colorless to clear brown. The solution is cooled and cannulated into a solution of trimethoxy borane at −78° C. One equivalent of linoleic magnesium bromide 2 yields the mono-substituted borane 3, while three equivalents of linoleic magnesium bromide yields the tris(linoleic)borane 5. The reaction is then quenched with water and the organics are extracted with ether. The organic layer is dried using sodium sulfate and the solvents removed by rotary evaporation. The drying oil is then purified on silica using a mobile phase of 90% hexanes and 10% ethyl acetate. The yield of useable material exceeds 90%.

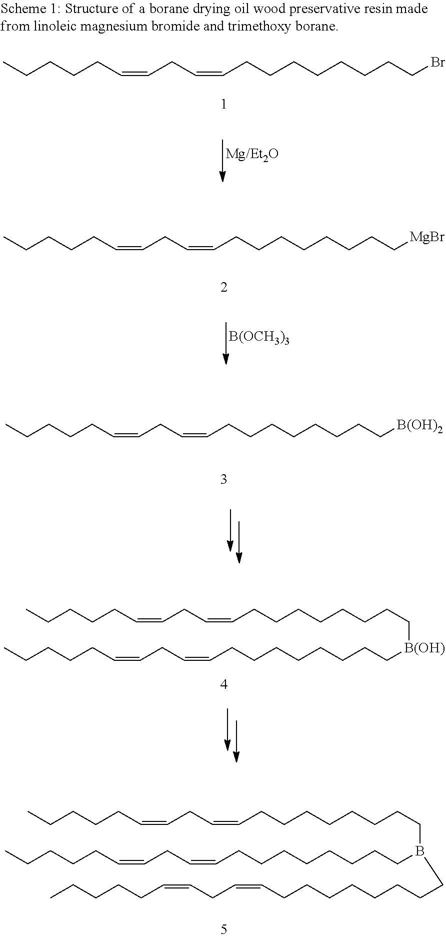

### Example 2

Synthesis of a borate wood preservative (Scheme 2) To 10 g B(Bu)₃ in toluene is added 15.6 g of linoleic acid 6 in toluene at room temperature. C₄H₁₀ is evolved and after 2 hours to form Bu₂BOC(O)C₁₇H₃₁ 7. The reaction was continued overnight to form BuB(OC(O)C₁₇H₃₁)₂, butylboryloxy-bis-[(6Z,9Z)-octadeca-6,9-diene-1-one] 8.

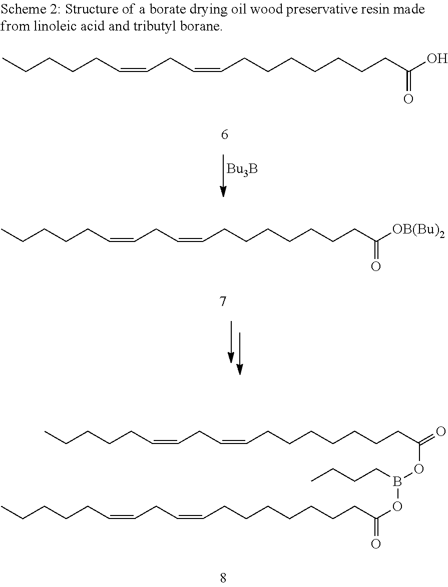

### Example 3

Pressure Treatment Process. Pressure treatment promotes penetration of the boron-containing compound into the wood. The treatment of the wood is carried out in closed vessels where the wood is exposed to the boron-containing compound and then pressure and/or vacuum is applied. The boron-containing compound penetrates deeply and uniformly into the wood. The conditions under which the boron-containing compound is applied can be controlled to vary the degree to which the boron-containing compound penetrates the wood and is retained. The pressure processes can be further adapted for large-scale protection of railroad ties, telephone poles, building members, structural materials, and so on.

### Example 4

Full-cell Process. The full-cell process is used as a variation of the pressure treatment process. However, in the full-cell process it is desirable to keep as much of boron-containing compound absorbed into the wood during the pressure period as possible. The desired retention of the boron-containing compound is achieved by changing the concentration of the solution.

### Example 5

Fluctuation Pressure Process. The fluctuation process is another variation of the pressure process. The fluctuation process is a “dynamic” process because the conditions under which the boron-containing compound is applied are constantly changing. The pressure inside the preservative application cylinder changes between vacuum and high pressure within a few seconds in the fluctuation process. This process is used for woods that can split or otherwise fail under other pressure application procedures. Generally, as a result of this fluctuation process, penetration depths of the preservatives may be limited.

### Example 6

Polymerization in wood. The boron-containing compound can be polymerized once it is within the wood structure. This step fixes the boron-containing compound into the wood structure, reducing or eliminating leaching out of the wood, and further serves to strengthen the wood. The boron-containing compound can be introduced into the wood structure by use of pressure, as described above, where it fills the fine grains and voids located within the wood. After the boron-containing compound is introduced into the wood structure, it can be heated to 65-75° C., causing the boron-containing compound to polymerize into a solid form.

### Example 7

Soil Block Test. The soil block test (AWPA, 2010) is a relatively rapid laboratory method for assessing the decay resistance of wood-based materials under conditions that favor rapid fungal attack of wood. Soil block tests were conducted upon blocks treated with compounds and compositions described herein. Leachates from the blocks were collected prior to fungal exposure and analyzed.

### Materials and Methods

Ponderosa pine (Pinus ponderosa L) sapwood blocks (19 mm cubes) were oven dried (60° C.) and weighed. The blocks were then randomly allocated, in groups of 12, to the various treatment groups. Treatment solutions containing actives (e.g., the compounds and compositions described herein) were supplied as 10% active ingredient concentrates. These solutions were then diluted with toluene to produce treatment solutions containing 0.1, 0.5, 1.0 and 3.0% active ingredient solutions. The blocks from a given group were placed in a container and covered with an excess of a given treatment solution. This container was placed in a desiccator. A vacuum was drawn over the vessel and then released. The blocks were removed from the treatment solution and blotted to remove excess solution before being weighed. The difference between the original dry weight and the wet weight was used to calculated net solution uptake. The blocks were stored wet for 3 days at 20-23° C. to allow any fixation reactions to proceed before being oven dried at 60° C. and weighed. The blocks were then conditioned to constant weight at 23° C. and 65% relative humidity prior to further testing.

Six blocks from each treatment group were subjected to a 14-day leaching procedure as described AWPA Standard E11-10 from the American Wood Preservers' Association's (AWPA) “Standard method of determining the leachability of wood preservatives” in the AWPA Book of Standards, Birmingham, Ala., 2010. The blocks were immersed in an excess of water, and subjected to a short vacuum. The water was then changed after 6, 24, and 48 hours of immersion and at 48 hour intervals over a total of 14 days. An aliquot of the leachate was retained at each time point for later analysis. The leached blocks were then reconditioned to constant weight at 23° C. and 65% relative humidity. Leachate collected at each time point was analyzed for boron using the azomethine H method as described in AWPA Standard A2-10 Method 16. All of the blocks were briefly soaked with water prior to being placed in plastic bags and sterilized by exposure to 2.5 mrad of ionizing radiation from a cobalt 60 source.

Decay chambers were prepared by half filling 454 ml French squares with moisture forest loam and placing a western hemlock feeder strip on the soil surface as described in AWPA Standard E10-10 “Standard method of testing wood preservatives by laboratory soil-block cultures.” The bottles were then loosely capped and autoclaved for 45 minutes at 121° C.

After cooling, the bottles were inoculated with 2 to 3 mm diameter malt agar disks cut from the actively growing edges of cultures of the test fungus, Gloeophyllum trabeum (Pers. ex Fr.) Murr. (Isolate: Madison 617). This fungus causes a brown rot of wood and tends to have some tolerance to boron compounds. The agar plugs were placed on the edges of the wood feeder strips, and the jars were loosely capped (to allow air exchange), and incubated until the feeder strip was thoroughly covered with fungal mycelium. The sterile test blocks were then placed on the surfaces of the feeder strips, the bottles were loosely capped and incubated at 28° C. for 12 weeks.

At the end of the incubation period, the blocks were removed, scraped clean of adhering mycelium and weighed to determine wet weight. The blocks were then oven dried (60° C.) and weighed. Differences between initial and final oven-dry weight were used as a measure of the decay resistance of each material.

### Results

Boron losses tended to be elevated in the first 2 to 3 leachate collections then flattened regardless of the formulation (FIG. 1). Total boron losses tended to be proportional to the dilution tested. For example, leachates from 3% dilutions tended to have 3 times as much boron in the leachate as a similar 1% dilution of the same treatment. Boron concentrations were highest in leachates from the borate solutions, followed by the borane and finally, the acrylic system.

Weight losses in blocks that were treated with either water or toluene ranged from 41% to 55% (Table 1). These values were indicative of an environment suitable for aggressive fungal attack. Samples treated 0.1% to 1.0% active ingredient were similar to those for the control, regardless of weight losses in blocks that were treated with either water or toluene ranged from 41% to 55% (Table 1). These values were indicative of an environment suitable for aggressive fungal attack. Leaching did not appear to have any effect on decay resistance, most likely because the weight losses on the non-leached samples were so high. Weight losses in the nonleached 3% borate treatments tended to be lower than those found for the other treatments. However, even these weight losses were well above those considered to show effective fungal control. Typically, fungal control was considered acceptable when weight losses fall below 2% to 3%. While formulations did appear to have differing degrees of resistance of leaching loss of boron, all the formulations were observed to have low leaching.

TABLE 1
Weight losses of treated and non-treated southern pine blocks
in a soil block test against Gloeophyllum trabeum.

| | | Average Wood Weight Loss | | | | |
|---|---|---|---|---|---|---|
| Treatment | Leaching | No boron | 0.1% B | 0.5% B | 1.0% B | 3.0% B |
| Borane | + | — | 48.4 (1.6) | 54.2 (12.4) | 59.8 (7.1) | 53.9 (13.3) |
| | + | — | 45.5 (2.30 | 53.6 (9.5) | 57.3 (4.8) | 39.2 (6.4) |
| Borate | + | — | 50.8 (4.2) | 46.5 (3.3) | 53.6 (4.3) | 51.8 (8.3) |
| | + | — | 53.8 (11.5) | 46.3 (2.4) | 48.3 (8.7) | 27.3 (6.9) |
| Toluene | + | 54.5 (13.3) | | | | |
| Control | − | 41.5 (4.6) | | | | |
| Water | + | 40.9 (4.9) | | | | |
| Control | − | 52.9 (12.9) | | | | |

Values represent means of 6 blocks per treatment. Figures in parentheses represent one standard deviation.
* The boron concentrations used in these tests were ~100 times less than the boron concentrations generally found in standard commercial borate formulations. Despite being used at such low concentrations, the boron-based preservatives were effective.

### Example 8

### Pyrolysis Testing

### Materials and Methods

A micro combustion calorimeter (MCC) or pyrolysis combustion flow calorimeter (PCFC) was used to measure the heat release of two samples, poly(isobornyl methacrylate), the control polymer, and a flame retardant boron-containing compound as described herein. The MCC measures the heat release of a material by oxygen consumption calorimetry and serves as a useful technique for assessing the heat release and flammability of many polymeric and organic materials.

MCC instruments expose a small sample (5-50 mg) to very fast heating rates to mimic fire type conditions. The sample can be pyrolyzed under an inert gas (nitrogen) at a fast heating rate, and the gases from the thermally decomposed product are then pushed into a 900° C. combustion furnace where they are mixed with oxygen. Alternatively, the sample can be thermally decomposed under oxidizing conditions (such as air, or a mixture of N₂ and O₂ up to 50%/50%) before going to the combustion furnace. After the gases from the pyrolyzed/thermally decomposed sample are combusted in the 900° C. furnace they are then flowed to an oxygen sensor, and the amount of oxygen consumed during that combustion process equals the heat release for the material at that temperature using Thornton's rule which is an empirical relationship, as known to the skilled artisan, that gives the average heat of combustion of oxygen with typical organic (C,H,N,O) gases, liquids, and solids.

The boron-containing compounds were tested in the MCC at 1° C./sec heating rate under nitrogen from 200° C. to 700° C. using method A of ASTM D7309 (pyrolysis under nitrogen). Each sample was tested in triplicate to evaluate reproducibility of the flammability measurements.

### Results

The following heat release measurements are shown in Table 2:

Char yield: This was obtained by measuring the sample mass before and after pyrolysis. The higher the char yield, the more carbon/inorganic material that was left behind. As more carbon was left behind, the total heat release generally decreased.

HRR Peak(s): This was the recorded peak maximum of heat release rate (HRR) found during each experiment. The higher the HRR value, the more heat that was given off at that event.

HRR Peak Temperatures: This was the temperature at which HRR was measured.

Total HR: This is the total heat release for the sample, which is the area under the curve(s) for each sample analysis.

Char Notes: These are description of the sample residues collected from each test.

TABLE 2

| | Char | HRR Peak(s) | HRR Peak | Total HR | Char |
|---|---|---|---|---|---|
| Sample | Yield % | Value W/g | Temp (° C.) | (KJ/mol) | Notes |
| 1 | 8.22 | 542, 214 | 335, 368 | 20.8 | * |
| 2 | 8.37 | 281, 247 | 349, 378 | 20.5 | * |
| 3 | 9.54 | 234 | 371 | 18.2 | * |
| 4 | 7.34 | 241 | 375 | 21.6 | * |
| Control A | 0.94 | 186, 827, 118 | 275, 335, 466 | 31.3 | ** |
| Control B | 1.03 | 253, 863, 118 | 287, 336, 465 | 31.4 | ** |
| Control C | 1.14 | 289, 858, 118 | 298, 335, 465 | 31.4 | ** |

* small amount of grey charring at center of pan.
** dull grey lining in pan

From the data in Table 2, the following conclusions can be made: The boron containing compounds show a higher char yield and a reduction in total heat release of about 35%. Compared to the control, the boron containing compounds also show lower peak heat release values. The final chars in the control sample leave very little char and flow all over the sample crucible, but the boron-containing compounds did not flow, suggesting that during burning they will not drip and flow.

Once the boron containing compound is polymerized within the wood structure it will not readily flow to the base of the wood structure and leak into the surrounding environment. Rather, the polymerized boron containing compounds will generally remain fixed throughout the treated wood structure and thereby persist within the wood structure for longer periods of time relative to existing liquid preservatives. Conversely, existing liquid preservatives can migrate from the wood structure into the surrounding environment, and leave the wood structure unprotected.

International PCT Application US 2012/48981, filed Jul. 31, 2012, is incorporated herein by reference in its entirety.

### EQUIVALENTS

The embodiments, illustratively described herein may suitably be practiced in the absence of any element or elements, limitation or limitations, not specifically disclosed herein. Thus, for example, the terms ‘comprising,’ including, ‘containing,’ etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase ‘consisting essentially of’ will be understood to include those elements specifically recited and those additional elements that do not materially affect the basic and novel characteristics of the claimed technology. The phrase ‘consisting of’ excludes any element not specified.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent compositions, apparatuses, and methods within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as ‘up to,’ ‘at least,’ ‘greater than,’ ‘less than,’ and the like, include the number recited and refer to ranges which can be subsequently broken down into subranges as discussed above. Similarly, the phrase “at least about” some value such as, e.g., wt % includes at least the value and about the value. For example “at least about 1 wt %” means “at least 1 wt % or about 1 wt %.” Finally, as will be understood by one skilled in the art, a range includes each individual member.

While certain embodiments have been illustrated and described, it should be understood that changes and modifications can be made therein in accordance with ordinary skill in the art without departing from the technology in its broader aspects as defined in the following claims.

1. A composition comprising a compound of Formula I: 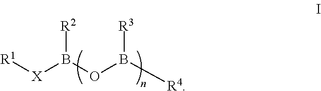
and an excipient for the treatment of a cellulosic material;
wherein:
each R¹ is independently selected from a C₈-C₃₆ alkyl group or a C₈-C₃₆ alkenyl group, wherein the C₈-C₃₆ alkyl or C₈-C₃₆ alkenyl is optionally substituted with a C₃-C₇ cycloalkyl, C₃-C₇ cycloalkenyl or C₃-C₇ heterocycloalkyl;
at least one R¹ is a C₈-C₃₆ polyunsaturated alkenyl optionally substituted with a C₃-C₇ cycloalkyl, C₃-C₇ cycloalkenyl or C₃-C₇ heterocycloalkyl;
R², R³, and R⁴ are independently OH, F, Cl, Br, I, O—C₁-C₆-alkyl, C₁-C₆ alkyl, OC(O)R¹, OCH₂R¹, or CH₂R¹;
X is —C(O)O— or —CH₂—; and
n is 0, 1, 2, 3, 4 or 5.

2. The composition of claim 1, wherein X is —C(O)O—.

3. (canceled)

4. The composition of claim 1, wherein X is —CH₂—.

5. The composition of claim 1, wherein the compound of Formula I is of Formula II: 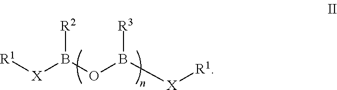
wherein each X is —C(O)O—.

6.-7. (canceled)

8. The composition of claim 1, wherein R² is OH.

9. The composition of claim 1, wherein R² is C₁-C₆ alkyl.

10. The composition of claim 1, wherein R² is butyl.

11. The composition of claim 1, wherein R² is —OC(O)R¹, —OCH₂R¹, or CH₂R¹.

12.-13. (canceled)

14. The composition of claim 1, wherein the compound of Formula I is of Formula III:

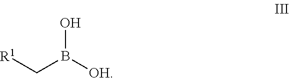

15. The composition of claim 1, wherein the compound of Formula I is of Formula IV:

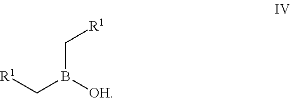

16. The composition of claim 1, wherein the compound of Formula I is of Formula V:

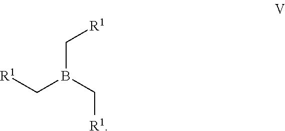

17. The composition of claim 1, wherein each R¹ is a C₈-C₃₆ alkyl or C₈-C₃₆ alkenyl independently selected from the hydrocarbon chain of lauric acid, myristic acid, myristoleic acid, palmitic acid, stearic acid, oleic acid, palmitoleic acid, or vaccenic acid, hexadecatrienoic acid, linoleic acid, α-linolenic acid, γ-linolenic acid, stearidonic acid, eicosatrienoic acid, eicosatetraenoic acid, eicosapentenoic acid, heneicosapentenoic acid, docosapentenoic acid, docosahexaenoic acid, tetracosapentenoic acid, tetracosahexaenoic acid, sapienic acid, elaidic acid, linoelaidic acid, α-eleostearic acid, β-eleostearic acid, arachidonic acid, erucic acid, caprylic acid, capric acid, arachidic acid, behenic acid, lignoceric acid, and cerotic acid.

18. The composition of claim 1, wherein each R¹ is a C₈-C₃₆ alkyl or C₈-C₃₆ alkenyl independently selected from the hydrocarbon chain of an oil selected from the group consisting of linseed, safflower, soybean, sunflower, tung, tall, castor, coconut, flaxseed, cotton, palm, canola, corn, oatmeal, almond peanut, grape, olive, and fish.

19. A composition comprising a compound of Formula VI: 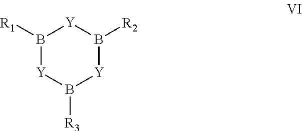
and an excipient for the treatment of a cellulosic material;
wherein:
each R¹ is independently selected from a C₈-C₃₆ alkyl group or a C₈-C₃₆ alkenyl group, wherein the C₈-C₃₆ alkyl or C₈-C₃₆ alkenyl is optionally substituted with a C₃-C₇ cycloalkyl, C₃-C₇ cycloalkenyl or C₃-C₇ heterocycloalkyl;
at least one R¹ is a C₈-C₃₆ polyunsaturated alkenyl optionally substituted with a C₃-C₇ cycloalkyl, C₃-C₇ cycloalkenyl or C₃-C₇ heterocycloalkyl;
R² and R³ are independently OH, F, Cl, Br, I, O—C₁-C₆-alkyl, C₁-C₆ alkyl, OC(O)R¹, OCH₂R¹, or CH₂R¹; and
Y is O or F.

20. The composition of claim 1, wherein the excipient is selected from the group consisting of an oil, drier, pigment, leveling agent, flatting agent, dispersing agent, flow control agent, ultraviolet (UV) absorber, plasticizer, and a combination of any two or more thereof.

21.-28. (canceled)

29. A process for preparing an article, wherein the article comprises a cellulosic material and a compound of Formula I or a polymerized reaction product of the compound of Formula I, the process comprising:
contacting a cellulosic material with a compound of Formula I; and
polymerizing the compound of Formula I: 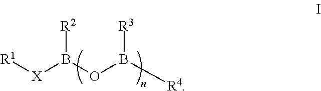
wherein:
each R¹ is independently selected from a C₈-C₃₆ alkyl group or a C₈-C₃₆ alkenyl group, wherein the C₈-C₃₆ alkyl or C₈-C₃₆ alkenyl is optionally substituted with a C₃-C₇ cycloalkyl, C₃-C₇ cycloalkenyl or C₃-C₇ heterocycloalkyl;
at least one R¹ is a C₈-C₃₆ polyunsaturated alkenyl optionally substituted with a C₃-C₇ cycloalkyl, C₃-C₇ cycloalkenyl or C₃-C₇ heterocycloalkyl;
R², R³, and R⁴ are independently OH, F, Cl, Br, I, O—C₁-C₆-alkyl, C₁-C₆ alkyl, OC(O)R¹, OCH₂R¹, or CH₂R¹;
X is —C(O)O— or —CH₂—; and
n is 0, 1, 2, 3, 4 or 5.

30. (canceled)

31. The process of claim 29, wherein the polymerizing comprises activating the compound of Formula I with heat, UV radiation, visible radiation, near-IR radiation, a thermal initiator, or a photochemical initiator.

32.-33. (canceled)

34. The process of claim 31, wherein the thermal initiator is 4,4-azobis(4-cyanovaleric acid), 1,1′-azobis(cyclohexanecarbonitrile), 2,2′-azobisisobutyronitrile, benzoyl peroxide, tert-butyl peracetate, lauroyl peroxide or dicumyl peroxide.

35. The process of claim 31, wherein the photochemical initiator is 3-butyl-2-[5-(1-butyl-3,3-dimethyl-1,3-dihydro-indol-2-ylidene)-penta-1,3-dienyl]-1,1-dimethyl-1H-benzo[e]indolium triphenylbutylborate, 3-butyl-2-[5-(3-butyl-1,1-dimethyl-1,3-dihydro-benzo[e]indol-2-ylidene)-penta-1,3-dienyl]-1,1-dimethyl-1H-benzo[e]indolium triphenylbutylborate or 6-hydroxy-2,4,5,7-tetraiodo-3-oxo-9,9a-dihydro-3H-xanthene-9-carbonitrile.

36.-37. (canceled)

38. The composition of claim 19, wherein each R¹ is a C₈-C₃₆ alkyl or C₈-C₃₆ alkenyl independently selected from the hydrocarbon chain of lauric acid, myristic acid, myristoleic acid, palmitic acid, stearic acid, oleic acid, palmitoleic acid, or vaccenic acid, hexadecatrienoic acid, linoleic acid, α-linolenic acid, γ-linolenic acid, stearidonic acid, eicosatrienoic acid, eicosatetraenoic acid, eicosapentenoic acid, heneicosapentenoic acid, docosapentenoic acid, docosahexaenoic acid, tetracosapentenoic acid, tetracosahexaenoic acid, sapienic acid, elaidic acid, linoelaidic acid, α-eleostearic acid, β-eleostearic acid, arachidonic acid, erucic acid, caprylic acid, capric acid, arachidic acid, behenic acid, lignoceric acid, and cerotic acid.

39. The composition of claim 19, wherein each R¹ is a C₈-C₃₆ alkyl or C₈-C₃₆ alkenyl independently selected from the hydrocarbon chain of an oil selected from the group consisting of linseed, safflower, soybean, sunflower, tung, tall, castor, coconut, flaxseed, cotton, palm, canola, corn, oatmeal, almond peanut, grape, olive, and fish.

40. The composition of claim 19, wherein the excipient is selected from the group consisting of an oil, drier, pigment, leveling agent, flatting agent, dispersing agent, flow control agent, ultraviolet (UV) absorber, plasticizer, and a combination of any two or more thereof.
